(19) United States
(12) Patent Application Publication
(10) Pub. No.: US 2022/0259449 A1
(43) Pub. Date: Aug. 18, 2022

(54) INK SET AND RECORDING HEAD INSPECTION METHOD

(71) Applicant: KYOCERA Document Solutions Inc., Osaka (JP)

(72) Inventor: Yasuko TAKAORI, Osaka-shi (JP)

(73) Assignee: KYOCERA Document Solutions Inc., Osaka (JP)

(21) Appl. No.: 17/665,745

(22) Filed: Feb. 7, 2022

(30) Foreign Application Priority Data
Feb. 16, 2021 (JP) 2021-022519

(51) Int. Cl. C09D 11/40; C09D 11/322; C09D 11/38; C09D 11/037; C09D 11/033; C09D 11/107; B41M 5/00; B41J 2/045

(52) U.S. Cl. CPC C09D 11/40; C09D 11/322; C09D 11/38; C09D 11/037; B41J 2/04586; C09D 11/107; B41M 5/0023; B41J 2/0451; C09D 11/033

(57) ABSTRACT

An ink set includes an inkjet ink and a recording head filling liquid. The inkjet ink contains a pigment, a pigment covering resin, a glycol ether compound, a first polyhydric alcohol compound, and water. The recording head filling liquid contains polyethylene glycol, a second polyhydric alcohol compound, a nonionic surfactant, and water. The polyethylene glycol has a mass average molecular weight of at least 190 and no greater than 420. A percentage content of the polyethylene glycol in the recording head filling liquid is at least 0.7% by mass and no greater than 12.0% by mass. A percentage content of the second polyhydric alcohol compound in the recording head filling liquid is at least 15.0% by mass and no greater than 45.0% by mass.

### INCORPORATION BY REFERENCE

The present application claims priority under 35 U.S.C. § 119 to Japanese Patent Application No. 2021-022519, filed on Feb. 16, 2021. The contents of this application are incorporated herein by reference in their entirety.

### BACKGROUND

The present disclosure relates to an ink set and a recording head inspection method.

An inkjet recording apparatus includes a recording head that ejects an inkjet ink. The recording head is a precision machine required to have extremely high precision. As such, a manufacturer of the recording head typically ships the recording head only after adequate inspection of ejection performance and the like of the recording head after manufacture thereof.

In inspection of ejection performance of the recording head, the recording head is filled with an inkjet ink and undergoes an ejection test. The inkjet ink inevitably remains in an ink flow channel of the recording head after the inspection. Due to the ink flow channel of the recording head being very fine, it is difficult to thoroughly remove the inkjet ink remaining in the ink flow channel even by washing of the recording head. When the recording head with the inkjet ink remaining in the ink flow channel thereof is shipped, a solvent of the inkjet ink may evaporate during transportation or storage to cause agglomeration of a solid content (particularly, a pigment component) of the inkjet ink, thereby generating agglomerate. The agglomerate serves as a cause of ejection failure of the recording head after shipping.

In view of the foregoing, the manufacturer of the recording head may ship the recording head with a solution (also referred to below as recording head filling liquid) containing no pigment component filled therein. The recording head filling liquid gets into the ink flow channel of the recording head to dilute the inkjet ink remaining in the ink flow channel. This makes it difficult for the solid content of the inkjet ink remaining in the ink flow channel to agglomerate. A recording head filling liquid such as above is required to be easily flow into the ink flow channel of the recording head and inhibit agglomeration of the solid content of the inkjet ink in the recording head. As a recording head filling liquid to be filled in the recording head, a recording head filling liquid containing a silicone oil is proposed, for example.

### SUMMARY

An ink set according to an aspect of the present disclosure includes an inkjet ink and a recording head filling liquid. The inkjet ink contains a pigment, a pigment covering resin, a glycol ether compound, a first polyhydric alcohol compound, and water. The recording head filling liquid contains polyethylene glycol, a second polyhydric alcohol compound, a nonionic surfactant, and water. The polyethylene glycol has a mass average molecular weight of at least 190 and no greater than 420. A percentage content of the polyethylene glycol in the recording head filling liquid is at least 0.7% by mass and no greater than 12.0% by mass. A percentage content of the second polyhydric alcohol compound in the recording head filling liquid is at least 15.0% by mass and no greater than 45.0% by mass.

A recording head inspection method according to an aspect of the present disclosure is a recording head inspection method using the aforementioned ink set, and includes: performing inspection to inspect ejection performance of a recording head; and filling the recording head filling liquid into the recording head after the performing inspection. In the performing inspection, the ejection performance of the recording head is inspected by ejecting the inkjet ink from the recording head.

### DETAILED DESCRIPTION

The following describes embodiments of the present disclosure. In the following, measured values for volume median diameter (D₅₀) are values as measured using a dynamic light scattering type particle size distribution analyzer (“ZETASIZER NANO ZS”, product of Malvern Instruments Ltd.) unless otherwise stated.

In the following, measured values for acid value are values as measured in accordance with “Japanese Industrial Standards (JIS) K0070-1992” unless otherwise stated. Also, measured values for mass average molecular weight (Mw) are values as measured by gel permeation chromatography unless otherwise stated.

In the present description, the term “(meth)acryl” is used as a generic term for both acryl and methacryl.

### First Embodiment: Ink Set

The following describes an ink set according to a first embodiment of the present disclosure. The ink set of the present disclosure includes an inkjet ink (also referred to below simply as an ink) and a recording head filling liquid (also referred to below simply as a filling liquid). The ink contains a pigment, a pigment covering resin, a glycol ether compound, a first polyhydric alcohol compound, and water. The filling liquid contains polyethylene glycol, a second polyhydric alcohol compound, a nonionic surfactant, and water. The polyethylene glycol has a mass average molecular weight of at least 190 and no greater than 420. The percentage content of the polyethylene glycol in the filling liquid is at least 0.7% by mass and no greater than 12.0% by mass. The percentage content of the second polyhydric alcohol compound in the filling liquid is at least 15.0% by mass and no greater than 45.0% by mass.

The filling liquid of the ink set of the present disclosure is used in a manner to be filled into a recording head in which the ink remains. In a situation for example in which a recording head is not used for a while for some reason after ink ejection by the recording head, the filling liquid is used in a manner to be filled into the recording head. Specifically, the filling liquid is used in a manner to be filled in the recording head in shipping of the recording head, long-term storage of the recording head, or transportation of the recording head. The ink set of the present disclosure is suitable as an ink set used in a recording head inspection method according to a second embodiment.

As a result of the ink set of the present disclosure having the above features, the filling liquid can easily flow into an ink flow channel of the recording head, the filling liquid can easily flow out of the recording head, and agglomeration of pigment components (the pigment and the pigment covering resin) of the ink in the recording head can be effectively inhibited. The reasons thereof are presumable as follows. The filling liquid contains the nonionic surfactant. The nonionic surfactant is compatible with the pigment covering resin. As such, the nonionic surfactant increases dispersibility of the pigment components (the pigment and the pigment covering resin) of the ink once the filling liquid is mixed with the ink. Furthermore, the nonionic surfactant reduces static surface tension of the filling liquid and makes the filling liquid easily flow into the ink flow channel of the recording head.

In addition, the ink flow channel of the recording head is connected to the outside air through openings (e.g., nozzle orifices). Accordingly, the water in the filling liquid filled in the recording head gradually evaporates to condense the other components. In view of the foregoing, the filling liquid is required to maintain a dissolved state of the nonionic surfactant even after the water in the filling liquid has evaporated. In view of the foregoing, the filling liquid contains polyethylene glycol. Polyethylene glycol is a component that readily dissolves the nonionic surfactant and that hardly volatilizes. As a result of containing polyethylene glycol, the filling liquid can maintain the dissolved state of the nonionic surfactant even when the water evaporates after the filling liquid is filled in the recording head.

Furthermore, the ink contains a glycol ether compound. The glycol ether compound increases permeability of the ink to a recording medium. By contrast, the glycol ether compound tends to decrease dispersion stability of the pigment components. Each of the ink and the filling liquid of the ink set of the present disclosure contains a polyhydric alcohol compound (first polyhydric alcohol compound or second polyhydric alcohol compound). The polyhydric alcohol compound reduces influence of the glycol ether compound on reducing dispersion stability of the pigment components. From the above, the ink set of the present disclosure can effectively inhibit agglomeration of the pigment components of the ink in the recording head.

In addition, the polyethylene glycol contained in the filling liquid has a relatively low molecular weight with a mass average molecular weight of at least 190 and no greater than 420, and accordingly does not increase the viscosity of the filling liquid so much. Therefore, the filling liquid has a relatively low viscosity. From the above, the filling liquid of the ink set of the present disclosure can easily flow into the ink flow channel of the recording head and the filling liquid can easily flow out of the recording head.

The ink set of the present disclosure will be described further in detail below. Note that each of the components described below may be used independently or two or more of the components may be used in combination.

[Ink]

The ink contains the pigment, a pigment covering resin, and water. The pigment forms pigment particles together with the pigment covering resin in the ink, for example. The pigment particles are present in a dispersed state in a solvent. In terms of improving color density, hue, or stability of the ink, the pigment particles have a D₅₀ of preferably at least 30 nm and no greater than 200 nm, and more preferably at least 70 nm and no greater than 130 nm.

(Pigment)

Examples of the pigment contained in the ink include yellow pigments, orange pigments, red pigments, blue pigments, violet pigments, and black pigments. Examples of the yellow pigments include C.I. Pigment Yellow (74, 93, 95, 109, 110, 120, 128, 138, 139, 151, 154, 155, 173, 180, 185, or 193). Examples of the orange pigments include C.I. Pigment Orange (34, 36, 43, 61, 63, or 71). Examples of the red pigments include C.I. Pigment Red (122 or 202). Examples of the blue pigments include C.I. Pigment Blue (15, specifically, 15:3). Examples of the violet pigments include C.I. Pigment Violet (19, 23, or 33). Examples of the black pigments include C.I. Pigment Black (7).

The percentage content of the pigment in the ink is preferably at least 1.0% by mass and no greater than 12.0% by mass, and more preferably at least 4.0% by mass, and no greater than 8.0% by mass. As a result of the percentage content of the pigment being set to at least 1.0% by mass, an image with a desired image density can be formed. As a result of the percentage content of the pigment being set to no greater than 12.0% by mass by contrast, fluidity of the ink can be increased.

(Pigment Covering Resin)

The pigment covering resin is a resin soluble in the ink. A portion of the pigment covering resin is present for example on the surfaces of the pigment particles to increase dispersibility of the pigment particles. Another portion of the pigment covering resin is present for example in a state of being dissolved in the ink.

The pigment covering resin is preferably a styrene-acrylic resin. The styrene-acrylic resin is a copolymer of styrene and at least one monomer of (meth)acrylic acid alkyl ester and (meth)acrylic acid. The styrene-acrylic resin preferably includes a repeating unit derived from (meth)acrylic acid ((meth)acrylic acid unit), a repeating unit derived from (meth)acrylic acid alkyl ester ((meth)acrylic acid alkyl ester unit), and a styrene unit.

Examples of the (meth)acrylic acid alkyl ester include methyl (meth)acrylate, ethyl (meth)acrylate, propyl (meth)acrylate, butyl (meth)acrylate, 2-ethylhexyl (meth)acrylate, and octyl(meth)acrylate. The (meth)acrylic acid alkyl ester is preferably methyl methacrylate or butyl acrylate.

The ratio of the (meth)acrylic acid unit to all repeating units included in the pigment covering resin is preferably at least 20% by mass and no greater than 60% by mass. The ratio of the (meth)acrylic acid alkyl ester unit to all repeating units included in the pigment covering resin is preferably at least 30% by mass and no greater than 65% by mass. The ratio of the styrene unit to all the repeating units included in the pigment covering resin is preferably at least 5% by mass and no greater than 25% by mass. Further preferably, the pigment covering resin is a resin including a repeating unit derived from methacrylic acid, a repeating unit derived from methyl methacrylate, a repeating unit derived from butyl acrylate, and a styrene unit.

The percentage content of the pigment covering resin in the ink is preferably at least 0.5% by mass and no greater than 8.0% by mass, and more preferably at least 1.5% by mass and no greater than 4.0% by mass. As a result of the percentage content of the pigment covering resin being set to at least 0.5% by mass, dispersibility of the pigment components can be increased. As a result of the percentage content of the pigment covering resin being set to no greater than 8.0% by mass, occurrence of nozzle clogging with the ink can be inhibited.

The pigment covering resin has an acid value of at least 50 mgKOH/g and no greater than 150 mgKOH/g, for example. As a result of the acid value of the pigment covering resin being set to at least 50 mgKOH/g and no greater than 150 mgKOH/g, dispersibility of the pigment components can be further increased and preservation stability of the ink can be increased.

The acid value of the pigment covering resin can be adjusted by changing the amount of a monomer used in synthesis of the pigment covering resin. For example, use of a monomer (specific examples include acrylic acid and methacrylic acid) having an acidic functional group (e.g., a carboxy group) can increase the acid value of the pigment covering resin.

The pigment covering resin has a Mw of at least 10,000 and no greater than 50,000, for example. As a result of the Mw of the pigment covering resin being set to at least 10,000 and no greater than 50,000, an increase in viscosity of the ink can be suppressed and an image with a desired image density can be formed.

The Mw of the pigment covering resin can be adjusted by changing a condition (specific examples include the amount of a polymerization initiator used, a polymerization temperature, and a polymerization time) for polymerization of the pigment covering resin.

The amount of the polymerization initiator used in polymerization of the pigment covering resin is preferably at least 0.001 mol and no greater than 5 mol relative to 1 mol of a monomer mixture, and more preferably at least 0.01 mol and no greater than 2 mol. In polymerization of the pigment covering resin, for example, the polymerization temperature may be 50° C. or higher and 70° C. or lower and the polymerization time may be 10 hours or longer and 24 hours or shorter. Note that polymerized pigment covering resin may be used directly as a raw material of the ink or used as a raw material of the ink after neutralization with an equivalent amount of a basic compound. The basic compound is preferably a hydroxide (e.g., NaOH) of an alkali metal ion.

(Water)

The water is a main solvent of the ink. The percentage content of the water in the ink is at least 40.0% by mass and no greater than 75.0% by mass, for example.

(Glycol Ether Compound)

The ink contains a glycol ether compound. The glycol ether compound increases permeability of the ink to the recording medium. The glycol ether compound is a general term for compounds with a structure in which a hydroxy group at one end or each end of a glycol compound is replaced with a hydrocarbon group (e.g., a methyl group, an ethyl group, a propyl group, or a butyl group).

Examples of the glycol ether compound include diethylene glycol diethyl ether, diethylene glycol monobutyl ether, ethylene glycol monomethyl ether, ethylene glycol monobutyl ether, diethylene glycol monomethyl ether, diethylene glycol monoethyl ether, diethylene glycol diethyl ether, triethylene glycol monomethyl ether, triethylene glycol monoethyl ether, triethylene glycol monobutyl ether, and propylene glycol monomethyl ether. The glycol ether compound in the ink is preferably triethylene glycol monobutyl ether.

The percentage content of the glycol ether compound in the ink is preferably at least 1.0% by mass and no greater than 30.0% by mass, and more preferably at least 5.0% by mass and no greater than 12.0% by mass. As a result of the percentage content of the glycol ether compound being set to at least 1.0% by mass, permeability of the ink to a recording medium can be increased. As a result of the percentage content of the glycol ether compound being set to no greater than 30.0% by mass, agglomeration of the pigment components of the ink in the recording head can be further effectively inhibited.

(First Polyhydric Alcohol Compound)

The first polyhydric alcohol compound reduces influence of the glycol ether compound on reducing dispersion stability of the pigment components. Examples of the first polyhydric alcohol compound include diol compounds (glycol), triol compounds, and sugar alcohols.

Examples of the first polyhydric alcohol include ethylene glycol, 1,3-propanediol, propylene glycol, 1,5-pentanediol, 1,2-octanediol, 1,8-octanediol, 3-methyl-1,5-pentanediol, diethylene glycol, triethylene glycol, tetraethylene glycol, 1,2,6-hexanetriol, thiodiglycol, hexilene glycol, glycerin, trimethylolethane, trimethylolpropane, and sorbitol. The first polyhydric alcohol compound is preferably 1,3-propanediol or glycerin.

The percentage content of the first polyhydric alcohol compound in the ink is preferably at least 3.0% by mass and no greater than 40.0% by mass, and more preferably at least 10.0% by mass and no greater than 20.0% by mass. As a result of the percentage content of the first polyhydric alcohol compound being set to at least 3.0% by mass and no greater than 40.0% by mass, agglomeration of the pigment components of the ink in the recording head can be further effectively inhibited.

(Additional Water-Soluble Organic Solvent)

Preferably, the ink further contains an additional water-soluble organic solvent in addition to the glycol ether compound and the first polyhydric alcohol compound. Examples of the additional water-soluble organic solvent in the ink include lactam compounds, nitrogen-containing compounds, acetate compounds, thiodiglycol, and dimethyl sulfoxide.

Examples of the lactam compounds include 2-pyrrolidone and N-methyl-2-pyrrolidone.

Examples of the nitrogen-containing compounds include 1,3-dimethylimidazolidinone, formamide, and dimethyl formamide.

Examples of the acetate compounds include diethylene glycol monoethyl ether acetate.

The additional water-soluble organic solvent in the ink is preferably 2-pyrrolidone.

The percentage content of the additional water-soluble organic solvent in the ink is preferably at least 1.0% by mass and no greater than 15.0% by mass, and more preferably at least 3.0% by mass and no greater than 10.0% by mass. As a result of the percentage content of the additional water-soluble organic solvent being set to at least 1.0% by mass and no greater than 15.0% by mass, ejection stability of the ink can be increased.

(Surfactant)

Preferably, the ink further contains a surfactant. The surfactant increases compatibility and dispersion stability of each component contained in the ink. The surfactant also increases permeability (wettability) of the ink to a recording medium. The surfactant in the ink is preferably a nonionic surfactant.

Examples of the nonionic surfactant in the ink include acetylene glycol-based surfactants (surfactants containing an acetylene glycol compound), silicone-based surfactants (surfactants containing a silicone compound), and fluorine-based surfactants (surfactants containing fluororesin or a fluorine-containing compound). Examples of the acetylene glycol-based surfactants include ethylene oxide adducts of acetylene glycol and propylene oxide adducts of acetylene glycol.

In a case in which the ink contains a surfactant, the percentage content of the surfactant in the ink is preferably at least 0.1% by mass and no greater than 2.0% by mass, and more preferably at least 0.2% by mass and no greater than 0.6% by mass.

(Additive)

The ink may further contain a known additive (e.g., a solution stabilizer, an anti-drying agent, an antioxidant, a viscosity modifier, a pH adjuster, and/or an antifungal agent) as necessary.

(Ink Production Method)

The ink can be produced for example by mixing water, a pigment dispersant, the glycol ether compound, the first polyhydric alcohol compound, and a component (e.g., the additional water-soluble organic solvent and the surfactant) added as necessary. The pigment dispersant contains the pigment, the pigment covering resin, and water. The pigment covering resin is prepared by neutralizing an alkali-soluble resin with an equivalent amount of a basic compound (e.g., NaOH). The pigment dispersant can be prepared by dispersing the pigment in a pigment covering resin-containing aqueous solution to which the pigment has been added. Examples of an apparatus used for dispersion include a bead mill. In ink production, foreign matter and coarse particles may be removed using a filter (e.g., a filter with a pore size of 5 μm) after mixing.

[Filling Liquid]

The filling liquid contains polyethylene glycol, a second polyhydric alcohol compound, a nonionic surfactant, and water.

The filling liquid preferably has a viscosity of at least 2.5 mPa·s and no greater than 10.0 mPa·s. As a result of having a viscosity of at least 2.5 mPa·s and no greater than 10.0 mPa·s, the filling liquid can further easily flow into the ink flow channel of the recording head and further easily flow out of the recording head. Measured values for viscosity of the filling liquid are values as measured at 25° C. using a rolling-ball viscometer (e.g., “LOVIS 2000”, product of Anton Paar Japan K.K.).

Relative energy difference (RED) between the filling liquid and the ink in Hansen solubility parameters is the key to determination as to whether or not the filling liquid can disperse the pigment components of the ink. The Hansen solubility parameters (HSPs) will be described first. The HSPs represent a value used for predicting solubility of a substance. The HSPs include the following three parameters (unit: MPa^{0.5}).

Dispersion parameter (dD): energy from dispersion forces between molecules

Polarization parameter (dP): energy from dipolar intermolecular force between molecules

Hydrogen bond parameter (dH): energy from hydrogen bonds between molecules

The three parameters of HSPs can be treated as coordinates for a point in a three-dimensional space known as the Hansen space. Where two specific substances are placed in the Hansen space, the closer the distance between the coordinates of the respective two substances is, the more approximate the properties of the two substances tend to be.

For a substance with unknown HSPs, the HSPs thereof can be determined by the following method. First, 1 part by mass of a substance (also referred to below as target substance) for which HSPs are to be determined and 49 parts by mass of a solvent (e.g., a solvent with literature values) of which HSPs are known are added into a sealable container. Next, the target substance and the solvent are sufficiently mixed by hand-shaking the container. Next, the container is left to stand for 12 hours in a normal temperature (23° C.) environment. Next, the container is turned upside down and the bottom of the container is observed. If neither precipitates nor agglomerate is present at the bottom of the container, it is determined that the solvent has dissolved the target substance. The above-described test is repeated while changing the type of the solvent as appropriate. Through the above repetition, a combination of ten solvents is determined that includes solvents that dissolve the target substance and solvents that do not dissolve the target substance. Of the ten solvents in the combination, it is preferable that about half (e.g., 4 to 6) of solvents are solvents that each dissolve the target substance and the rest solvents are solvents that each do not dissolve the target substance. A sphere called Hansen sphere is drawn in the Hansen space based on the test results for the ten solvents.

A method for drawing a Hansen sphere will be described. In the Hansen space, a sphere (Hansen sphere) is drawn that includes coordinates of each solvent having dissolved the target substance and that does not include coordinates of each solvent not having dissolved the target substance. The center coordinates of the drawn Hansen sphere indicate the HSPs of the target substance. The size of the Hansen sphere differs depending on the type of the target substance. In detail, the Hansen sphere of a target substance that dissolves various solvents with different properties has a large interaction radius R₀. By contrast, the Hansen sphere of a target substance that dissolves only a limited solvent with a specific property has a small interaction radius R₀.

The following describes a specific method for predicting solubility between two substances (e.g., a filling liquid X and an ink Y) using HSPs. First, the two substances are placed in the Hansen space based on the respective HSPs. Then, the distance Rₐ between the coordinates of the two substances is calculated. The shorter the distance Rₐ is, the more likely the two substances are to dissolve into each other. The distance Rₐ between the coordinates of the two substances can be calculated using the following formula (R).

$${R}_{a} = \sqrt{4 \times {( dDx - dDy )}^{2} + {( dPx - dPy )}^{2} + {( dHx - dHy )}^{2}} \qquad ( R )$$

In formula (R), dDx, dPx, and dHx represent a dispersion parameter (dD), a polarization parameter (dP), and a hydrogen bond parameter (dH), respectively, of the filling liquid X. dDy, dPy, and dHy represent a dispersion parameter (dD), a polarization parameter (dP), and a hydrogen bond parameter (dH), respectively, of the ink Y.

When the ink set of the present disclosure is applied to the above, the distance Rₐ between the filling liquid and the ink in the Hansen space is calculated using the following formula (R-1).

$${R}_{a} = \sqrt{4 \times {( dDs - dDp )}^{2} + {( dPs - dPp )}^{2} + {( dHs - dHp )}^{2}} \qquad ( R ‐ 1 )$$

In formula (R-1), dDs, dPs, and dHs represent a dispersion parameter (dD), a polarization parameter (dP), and a hydrogen bond parameter (dH), respectively, of the filling liquid. dDp, dPp, and dHp represent a dispersion parameter (dD), a polarization parameter (dP), and a hydrogen bond parameter (dH), respectively, of the ink.

Whether or not the ink Y will dissolve in the filling liquid X is determined based on whether or not the Hansen sphere of the ink Y includes the coordinates of the HSPs of the filling liquid X in the Hansen space. Specifically, whether or not the ink Y will dissolve in the filling liquid X is determined according to a ratio (Rₐ/R₀) of the distance Rₐ between the two substances to the radius R₀ of the Hansen sphere of the ink Y. In the following, the ratio (Rₐ/R₀) may be referred to as relative energy difference (RED) (formula (r) below). If the RED is less than 1, which means that the coordinates of the HSPs of the filling liquid X are present within the Hansen sphere of the ink Y, the ink Y will dissolve in the filling liquid Y. If the RED is greater than 1 by contrast, which means that the coordinates of the HSPs of the filling liquid X are present outside the Hansen sphere of the ink Y, the ink Y will not dissolve in the filling liquid Y. Note that the RED is just 1, the ink Y will partially dissolve in the filling liquid X.

RED=Rₐ/R₀ (r)

In a case in which the filling liquid X is a solvent mixture, the HSPs of the filling liquid X can be calculated by the following method. For each solvent constituting the filling liquid X, a product A of the dispersion parameter (dD) of the solvent and a mass ratio (ratio of mass of the solvent to mass of the filling liquid X) of the solvent is calculated first. Next, the products A of the solvents are summed to calculate a sum B. The sum B is taken to be a dispersion parameter (dD) of the solvent mixture. The polarization parameter (dP) and the hydrogen bond parameter (dH) of the filling liquid X can be calculated by a method similar to that for calculating the dispersion parameter (dD) of the filling liquid X. The HSPs of the filling liquid X that is a solvent mixture are calculated in the manner as described above.

The RED between the filling liquid and the ink in the Hansen solubility parameters is preferably at least 0.55 and no greater than 0.85, and more preferably at least 0.65 and no greater than 0.80. In also the Hansen solubility parameters, the RED between the ink and a solution (solution containing for example polyethylene glycol, the second polyhydric alcohol compound, a nonionic surfactant, and an additional water-soluble organic solvent described later) obtained by removing the water from the filling liquid is preferably less than 1.00, and more preferably at least 0.80 and less than 1.00. When the RED falls in the above range, the filling liquid can further effectively inhibit agglomeration of the pigment components of the ink in the recording head. Note that the RED between the ink and the solution obtained by removing the water from the filling liquid is a value on the assumption of a situation in which water after mixing of the filling liquid and the ink has evaporated due to dryness in the recording head. When the RED between the ink and the solution obtained by removing the water from the filling liquid is less than 1.00, it can be determined that the pigment components of the ink can sufficiently disperse in the filling liquid even in a situation in which water after mixing of the filling liquid and the ink has evaporated due to dryness in the recording head.

(Polyethylene Glycol)

The polyethylene glycol in the filling liquid has a mass average molecular weight (Mw) of at least 190 and no greater than 420, and preferably at least 190 and no greater than 250. Polyethylene glycol with a mass average molecular weight of at least 190 has low volatility. As such, as a result of the mass average molecular weight of the polyethylene glycol being set to at least 190, the polyethylene glycol can be inhibited from volatizing in the recording head filled with the filling liquid. As a result of the mass average molecular weight of the polyethylene glycol being set to no greater than 420, viscosity of the filling liquid can be reduced moderately. This can allow the filling liquid to easily flow into the ink flow channel of the recording head and easily flow out of the recording head.

The percentage content of the polyethylene glycol in the filling liquid is at least 0.7% by mass and no greater than 12.0% by mass, and preferably at least 3.0% by mass and no greater than 7.5% by mass. As a result of the percentage content of the polyethylene glycol in the filling liquid being set to at least 0.7% by mass, the dissolved state of the nonionic surfactant can be maintained even in a situation in which the water in the filling liquid filled in the recording head has evaporated. As a result of the percentage content of the polyethylene glycol in the filling liquid being set to no greater than 12.0% by mass, viscosity of the filling liquid can be reduced moderately. This can allow the filling liquid to easily flow into the ink flow channel of the recording head and easily flow out of the recording head.

(Second Polyhydric Alcohol Compound)

The second polyhydric alcohol compound reduces influence of the glycol ether compound contained in the ink on reducing dispersion stability of the pigment components. Examples of the second polyhydric alcohol compound include the same compounds as those listed as the examples of the first polyhydric alcohol compound. The second polyhydric alcohol compound is preferably glycerin, 1,3-propanediol, or propylene glycol.

The percentage content of the second polyhydric alcohol compound in the filling liquid is at least 15.0% by mass and no greater than 45.0% by mass, and preferably at least 30.0% by mass and no greater than 42.0% by mass. As a result of the percentage content of the second polyhydric alcohol compound being set to at least 15.0% by mass and no greater than 45.0% by mass, agglomeration of the pigment components of the ink in the recording head can be effectively inhibited.

(Nonionic Surfactant)

Examples of the nonionic surfactant contained in the filling liquid include the same nonionic surfactants as those listed as the examples of the nonionic surfactant in the ink. The nonionic surfactant contained in the filling liquid is preferably an acetylene glycol-based surfactant. An acetylene glycol-based surfactant exerts an effect of increasing wettability of the filling liquid to a stainless steel material that is typically used as a material of the ink flow channel of the recording head. As such, the filling liquid containing an acetylene glycol-based surfactant can further easily flow into the ink flow channel of the recording head.

The percentage content of the nonionic surfactant in the filling liquid is preferably at least 0.01% by mass and no greater than 0.10% by mass, and more preferably at least 0.03% by mass and no greater than 0.07% by mass. As a result of the percentage content of the nonionic surfactant in the filling liquid being set to at least 0.01% by mass, the filling liquid further easily flows into the ink flow channel of the recording head and the pigment components of the ink can be further effectively inhibited from agglomerating in the recording head. By contrast, a large amount of the nonionic surfactant may rather reduce dispersibility of the pigment components. As such, as a result of the percentage content of the nonionic surfactant in the filling liquid being set to no greater than 0.10% by mass, the filling liquid can further effectively inhibit the pigment components of the ink from agglomerating in the recording head.

(Water)

The water is a main solvent of the filling liquid. The percentage content of the water in the filling liquid is at least 45.0% by mass and no greater than 80.0% by mass, for example.

(Additional Water-Soluble Organic Solvent)

The filling liquid may further contain an additional water-soluble organic solvent. Examples of the additional water-soluble organic solvent include the same water-soluble organic solvents as those listed as the examples of the additional water-soluble organic solvent in the ink.

(Additive)

The filling liquid may further contain a known additive (e.g., a solution stabilizer, an anti-drying agent, an antioxidant, a viscosity modifier, a pH adjuster, and/or an antifungal agent) as necessary.

(Filling Liquid Production Method)

The filling liquid can be produced for example by mixing polyethylene glycol, the second polyhydric alcohol compound, the nonionic surfactant, and water.

### Second Embodiment: Recording Head Inspection Method

The following describes a recording head inspection method according to a second embodiment of the present disclosure. The recording head inspection method of the present disclosure is a recording head inspection method using the ink set according to the first embodiment, and includes: performing inspection to inspect ejection performance of a recording head; and filling the filling liquid into the recording head after the performing inspection. In the performing inspection, the ejection performance of the recording head is inspected by ejecting the ink from the recording head.

Because the recording head inspection method of the present disclosure uses the ink set of the first embodiment, ejection failure can be prevented from occurring in the recording head after inspection. The recording head inspection method of the present disclosure is performed for example by a manufacturer of the recording head before shipping of the recording head. Although no particular limitations are placed on a recording head to be inspected by the recording head inspection method of the present disclosure, the recording head may be a piezoelectric inkjet recording head or a thermal inkjet recording head, for example.

[Performing Inspection]

In the performing inspection, ejection performance of the recording head is inspected. Specifically, ejection performance of the recording head is inspected by ejecting the ink from the recording head in the performing inspection. The ink remains in the ink flow channel of the recording head after the performing inspection.

The performing inspection may include washing the recording head after inspection. Although no particular limitations are placed on the method for washing the recording head, examples of the method include a method in which a wash fluid is filled into the recording head and then ejected from the recording head. Examples of the wash fluid include water or a wash fluid containing a water-soluble organic solvent. It is difficult to thoroughly remove the ink in the ink flow channel even by washing the recording head in the performing inspection.

[Filling]

The filling liquid is filled into the recording head in the filling. After the filling, the recording head is stored for shipment or transported for shipment, for example. After the recording head is delivered to a user, the filling liquid can flow out of the recording head by ejecting the filling liquid from the recording head.

### Examples

The following describes examples of the present disclosure. However, the present disclosure is not limited to the following examples.

[Preparation of Pigment Covering Resin (R-1)]

An alkali-soluble resin was prepared that included a repeating unit (MAA unit) derived from methacrylic acid, a repeating unit (MMA unit) derived from methyl methacrylate, a repeating unit (BA unit) derived from butyl acrylate, and a repeating unit (ST unit) derived from styrene. The alkali-soluble resin had a mass average molecular weight (Mw) of 20,000 and an acid value of 100 mgKOH/g. The mass ratio (MAA unit:MMA unit:BA unit:ST unit) of the repeating units in the alkali-soluble resin was 40:15:30:15. The alkali-soluble resin was mixed with an aqueous sodium hydroxide solution containing sodium hydroxide (neutralization). By the neutralization, the alkali-soluble resin was neutralized with an equivalent amount (strictly speaking, 105% amount) of NaOH. Through the above, a pigment covering resin solution was obtained that contained a pigment covering resin (R-1) and water.

The Mw of the resultant alkali-soluble resin was measured using a gel permeation chromatography system (“HLC-8020GPC”, product of Tosoh Corporation) under the following conditions. A calibration curve was plotted using n-propylbenzene and F-40, F-20, F-4, F-1, A-5000, A-2500, and A-1000 that each are TSKgel standard polystyrene produced by Tosoh Corporation.

(Mass Average Molecular Weight Measurement Conditions)

Column: “TSKgel SuperMultiporeHZ-H” produced by Tosoh Corporation (semi-micron column with a dimension of 4.6 mm ID×15 cm)

Number of columns: 3

Eluent: tetrahydrofuran

Flow rate: 0.35 mL/min.

Sample injection amount: 10 μL

Measurement temperature: 40° C.

Detector: IR detector

[Pigment Dispersion Preparation]

A pigment (a black pigment, a magenta pigment, a cyan pigment, or a yellow pigment), the pigment covering resin solution containing the pigment covering resin (R-1), and ion exchange water at a ratio shown in Table 1 below were added into a 1.4-L vessel. Next, the vessel contents were wet-dispersed using a media type wet disperser (“DYNO (registered Japanese trademark)-MILL”, product of Willy A. Bachofen AG (WAB)).

Details of each pigment in Table 1 below are as shown below.

Black pigment: carbon black

Magenta pigment: quinacridone, color index: Pigment Red 122

Cyan pigment: “LIONOL (registered Japanese trademark) Blue FG-7330”, product of TOYOCOLOR CO., LTD., component: copper phthalocyanine, color index: Pigment Blue 15:3

Yellow pigment: 2-[(2-methoxy-4-nitrophenyl)azo]-N-(2-methoxyphenyl)-3-oxobutaneamide, color index: Pigment Yellow 74

Note that each percentage content of “water” in Table 1 below indicates a total percentage content of ion exchange water added into the vessel and water contained in the pigment covering resin solution (specifically, water contained in the aqueous sodium hydroxide solution used for neutralization of the alkali-soluble resin and water produced in the neutralization reaction of the alkali-soluble resin and sodium hydroxide).

TABLE 1

| Pigment dispersion | | D-Y | D-M | D-C | D-K |
|---|---|---|---|---|---|
| Percentage | Water | 80.0 | 80.0 | 80.0 | 80.0 |
| content | Pigment covering resin (R-1) | 5.0 | 5.0 | 5.0 | 5.0 |
| [% by mass] | (NaOH neutralization) | | | | |
| | Yellow pigment | 15.0 | — | — | — |
| | Magenta pigment | — | 15.0 | — | — |
| | Cyan pigment | — | — | 15.0 | — |
| | Black pigment | — | — | — | 15.0 |
| | Total | 100.0 | 100.0 | 100.0 | 100.0 |

Subsequently, the vessel contents were dispersed using zirconia beads (particle diameter 0.5 mm) being a medium and a wet disperser (“NANO GRAIN MILL”, product of Asada Iron Works Co., Ltd.). The amount of the medium charged was 70% by mass relative to the capacity of the vessel. The conditions for dispersion included a temperature of 10° C. and a peripheral speed of 8 m/sec. Pigment dispersants (D-Y), (D-M), (D-C), and (D-K) were obtained in the manner described above.

The volume median diameter (D₅₀) of the pigment particles contained in each of the resultant pigment dispersions (D-Y) to (D-K) was measured. In detail, each of the resultant pigment dispersions (pigment dispersions (D-Y) to (D-K)) was diluted 300 times with ion exchange water and the resultant product was taken to be a measurement sample. A D₅₀ of the pigment particles in the measurement sample was measured using a dynamic light scattering type particle size distribution analyzer (“ZETASIZER NANO ZS”, product of Malvern Instruments Ltd.). The D₅₀ of the pigment particles in each measurement sample was taken to be a D₅₀ of the pigment particles contained in a corresponding one of the pigment dispersions (D-Y) to (D-K). The D₅₀ of the pigment particles contained in each of the pigment dispersions (D-Y) to (D-K) was 100 nm.

[Preparation of Ink (I-1)]

Ion exchange water was added into a flask equipped with a stirrer (“THREE-ONE MOTOR (registered Japanese trademark) BL-600”, product of Shinto Scientific Co., Ltd.). While the flask contents were stirred using the stirrer (stirring speed: 400 rpm), the pigment dispersion (D-K), 1,3-propanediol (1,3-PD), triethylene glycol monobutyl ether (BTG), 2-pyrrolidone, a surfactant (“SURFYNOL (registered Japanese trademark) 420”, product of Nissin Chemical Industry Co., Ltd, acetylene glycol-based surfactant), and glycerin were added into the flask. The ratio of the added raw materials was set as shown in Table 2 below.

[Preparation of Inks (I-2) to (I-6)]

Inks (I-2) to (I-6) were prepared according to the same method as that for preparing the ink (I-1) in all aspects except that the type and amount added of each raw material were changed to those shown in Table 2 below.

The abbreviations in Table 2 below are explained below.

1,3-PD: 1,3-propanediol

BTG: triethylene glycol monobutyl ether

DGMBE: diethylene glycol monobutyl ether

TABLE 2

| Ink | | | I-1 | I-2 | I-3 | I-4 | I-5 | I-6 |
|---|---|---|---|---|---|---|---|---|
| Amount | Pigment | D-K | 40.0 | — | — | — | — | — |
| added | dispersion | D-Y | — | 40.0 | — | — | — | — |
| [% by mass] | | D-M | — | — | 40.0 | — | — | — |
| | | D-C | — | — | — | 40.0 | 40.0 | 40.0 |
| | Polyhydric | 1,3-PD | 8.0 | 8.0 | 8.0 | 8.0 | 8.0 | — |
| | alcohol | Glycerin | 7.0 | 7.0 | 7.0 | 7.0 | 7.0 | — |
| | compound | | | | | | | |
| | Glycol | BTG | 8.0 | 8.0 | 8.0 | 8.0 | — | 8.0 |
| | ether | DGMBE | — | — | — | — | 8.0 | — |

| | | | | | | |
|---|---|---|---|---|---|---|
| 2-Pyrrolidone | 5.0 | 5.0 | 5.0 | 5.0 | 5.0 | 5.0 |
| Surfactant | 0.4 | 0.4 | 0.4 | 0.4 | 0.4 | 0.4 |
| Ion exchange water | Rest | Rest | Rest | Rest | Rest | Rest |
| Total | 100.0 | 100.0 | 100.0 | 100.0 | 100.0 | 100.0 |

In order to remove foreign matter and coarse particles from the resultant mixed liquid, the mixed liquid was filtered using a filter with a pore size of 5 μm. The inks (I-1) to (I-6) were obtained in the manner described above.

[Preparation of Filling Liquids (F-1) to (F-12)]

Filling liquids (F-1) to (F-12) were prepared according to the following methods. Details of components used for filling liquid preparation are shown below.

PEG-200: polyethylene glycol (“PEG-200”, product of Sanyo Chemical Industries, Ltd.), mass average molecular weight 200

PEG-300: polyethylene glycol (“PEG-300”, product of Sanyo Chemical Industries, Ltd.), mass average molecular weight 300

PEG-600: polyethylene glycol (“PEG-600”, product of Sanyo Chemical Industries, Ltd.), mass average molecular weight 600

PPG: polypropylene glycol (“Polypropylene Glycol, Diol Type, 400”, product of FUJIFILM Wako Pure Chemical Corporation), mass average molecular weight 400

1,3-PD: 1,3-propanediol

TEG: triethylene glycol

BTG: triethylene glycol monobutyl ether

MPD: 3-methyl-1,5-pentanediol

Surfactant N-1: “OLFINE (registered Japanese trademark) Exp4300”, product of Nissin Chemical Industry Co., Ltd., acetylene glycol-based surfactant (nonionic surfactant)

Surfactant N-2: “SURFYNOL (registered Japanese trademark) 440”, product of Nissin Chemical Industry Co., Ltd., acetylene glycol-based surfactant (nonionic surfactant)

Surfactant N-3: “OLFINE (registered Japanese trademark) E1010”, product of Nissin Chemical Industry Co., Ltd., acetylene glycol-based surfactant (nonionic surfactant)

Surfactant C-1: “CATIOGEN (registered Japanese trademark) BC-50”, product of DKS Co. Ltd., quaternary ammonium salt (cationic surfactant)

(Preparation of Filling Liquids (F-1))

A mixed liquid was obtained by mixing 5.0 parts by mass of PEG-200 described above, 40.0 parts by mass of glycerin, 0.05 parts by mass of the surfactant N-1, and ion exchange water. The amount (54.95 parts by mass) of the ion exchange water added was set so that the total amount of the mixed liquid was 100 parts by mass. The resultant mixed liquid was taken to be the filling liquid (F-1).

(Preparation of Filling Liquids (F-2) to (F-19))

The filling liquids (F-2) to (F-19) were prepared according to the same method as that for preparing the filling liquids (F-1) in all aspects except that the type and amount added of each raw material were changed to those as shown in Tables 3 to 5 below.

A viscosity of each of the filling liquids (F-1) to (F-19) was measured according to the method described in the first embodiment. Measurement results are shown in Tables 3 to 5 below.

TABLE 3

| Filling liquid | | | F-1 | F-2 | F-3 | F-4 | F-5 | F-6 |
|---|---|---|---|---|---|---|---|---|
| Amount | PEG | PEG-200 | 5.0 | 5.0 | 10.0 | 1.0 | — | 5.0 |
| added | | PEG-400 | — | — | — | — | 5.0 | — |
| [part by mass] | | PEG-600 | — | — | — | — | — | — |
| | PPG | | — | — | — | — | — | — |
| | TEG | | — | — | — | — | — | — |
| | Polyhydric | Glycerin | 40.0 | 20.0 | 40.0 | 40.0 | 40.0 | 40.0 |
| | alcohol | 1,3-PD | — | — | — | — | — | — |
| | compound | PG | — | — | — | — | — | — |
| | Surfactant | N-1 | 0.05 | 0.05 | 0.05 | 0.05 | 0.05 | — |
| | | N-2 | — | — | — | — | — | 0.5 |
| | | N-3 | — | — | — | — | — | — |
| | | C-1 | — | — | — | — | — | — |

| | | | | | | | |
|---|---|---|---|---|---|---|---|
| | Ion exchange water | Rest | Rest | Rest | Rest | Rest | Rest |
| | Total | 100.0 | 100.0 | 100.0 | 100.0 | 100.0 | 100.0 |
| Property | Viscosity [mPa · s] | 4.0 | 3.0 | 5.0 | 4.5 | 5.0 | 4.0 |

TABLE 4

| Filling liquid | | | F-7 | F-8 | F-9 | F-10 | F-11 | F-12 |
|---|---|---|---|---|---|---|---|---|
| Amount | PEG | PEG-200 | 5.0 | 5.0 | 5.0 | 15.0 | 0.5 | 5.0 |
| added | | PEG-400 | — | — | — | — | — | — |
| [part by mass] | | PEG-600 | — | — | — | — | — | — |
| | PPG | | — | — | — | — | — | — |
| | TEG | | — | — | — | — | — | — |
| | Polyhydric | Glycerin | 40.0 | — | — | 30.0 | 40.0 | 10.0 |
| | alcohol | 1,3-PD | — | 40.0 | — | — | — | — |
| | compound | PG | — | — | 40.0 | — | — | — |
| | Surfactant | N-1 | — | 0.05 | 0.05 | 0.05 | 0.05 | 0.05 |
| | | N-2 | — | — | — | — | — | — |
| | | N-3 | 0.7 | — | — | — | — | — |
| | | C-1 | — | — | — | — | — | — |

| | | | | | | | |
|---|---|---|---|---|---|---|---|
| | Ion exchange water | Rest | Rest | Rest | Rest | Rest | Rest |
| | Total | 100.0 | 100.0 | 100.0 | 100.0 | 100.0 | 100.0 |
| Property | Viscosity [mPa · s] | 4.0 | 3.0 | 5.0 | 6.0 | 4.0 | 2.0 |

TABLE 5

| Filling liquid | | | F-13 | F-14 | F-15 | F-16 | F-17 | F-18 | F-19 |
|---|---|---|---|---|---|---|---|---|---|
| Amount | PEG | PEG-200 | 5.0 | 5.0 | — | — | — | 5.0 | 5.0 |
| added | | PEG-400 | — | — | — | — | — | — | — |
| [part by mass] | | PEG-600 | — | — | 5.0 | — | — | — | — |
| | PPG | | — | — | — | 5.0 | — | — | — |
| | TEG | | — | — | — | — | 5.0 | — | — |
| | Polyhydric | Glycerin | 50.0 | 40.0 | 40.0 | 40.0 | 40.0 | — | 40.0 |
| | alcohol | 1,3-PD | — | — | — | — | — | — | — |
| | compound | PG | — | — | — | — | — | — | — |
| | MPD | | — | — | — | — | — | 20.0 | — |
| | Surfactant | N-1 | 0.05 | — | 0.05 | 0.05 | 0.05 | 0.05 | — |
| | | N-2 | — | — | — | — | — | — | — |
| | | N-3 | — | — | — | — | — | — | — |
| | | C-1 | — | — | — | — | — | — | 0.5 |

| | | | | | | | | |
|---|---|---|---|---|---|---|---|---|
| | Ion exchange water | Rest | Rest | Rest | Rest | Rest | Rest | Rest |
| | Total | 100.0 | 100.0 | 100.0 | 100.0 | 100.0 | 100.0 | 100.0 |
| Property | Viscosity [mPa · s] | 6.0 | 4.0 | 12.0 | 10.0 | 4.0 | 8.0 | 4.0 |

<Ink Set Preparation>

Any one of the inks (I-1) to (I-6) and any one of the filling liquids (F-1) to (F-19) were combined as shown in Tables 6 to 8 below. Thus, ink sets of Examples 1 to 19 and Comparative Examples 1 to 11 were prepared.

<Evaluation>

With respect to each of the ink sets of Examples 1 to 19 and Comparative Examples 1 to 11, whether or not agglomeration of a corresponding ink was inhibited, filling liquid flow-out ability (property of a corresponding filling liquid to easily flow out of a recording head), filling liquid flow-in ability (property of a corresponding filling liquid to easily flow into an ink flow channel of the recording head), and a relative energy difference (RED) in the Hansen solubility parameters were measured according to the following methods. Measurement results are shown in Tables 6 to 8 below. Note that each evaluation was performed at a temperature of 25° C. and a relative humidity of 20% unless otherwise noted.

(Agglomeration Inhibition (Under Evaporation))

With respect to each ink set that is an evaluation target, 1 part by mass of a corresponding ink (any of the inks (I-1) to (I-6)) and 50 parts by mass of a corresponding filling liquid (any of the filling liquids (F-1) to (F19)) were mixed in a beaker. Next, the beaker containing the resultant mixed liquid was stored (storage) without being sealed in a constant temperature bath at 40° C. for 1 month. The mixed liquid after the storage reduced in volume by approximately 50% due to evaporation (mainly, evaporation of water). With respect to the mixed liquid after the storage, the presence or absence of agglomerate with a particle diameter of at least 3 μm was analyzed using a particle shape image analyzer (“FPIA-3000”, product of Malvern Panalytical Ltd.). Agglomeration inhibition (under evaporation) of the ink was evaluated as “A (acceptable)” if agglomerate with a particle diameter of at least 3 μm was not generated after the storage, and evaluated as “B (rejected)” if agglomerate with a particle diameter of at least 3 μm was generated after the storage.

Note that when a filling liquid is filled into a recording head after inspection of the recording head, residual ink and the filling liquid were mixed together in the recording head. The mixing ratio (amount of ink/amount of filling liquid) between the residual ink and the filling liquid varies depending on parts of the recording head, but is expected to be about 1/50 at maximum. Therefore, the mixing ratio between the ink and the filling liquid was assumed to be 1 part by mass (ink): 50 parts by mass (filling liquid). Furthermore, agglomerate with a particle diameter of at least 3 μm generated within the recording head may cause clogging of a filter disposed inside the recording head to lead to ejection failure of the ink. Therefore, whether or not agglomerate with a particle diameter of at least 3 μm was generated after the storage was used as a criterion for determination as to whether or not agglomeration of the ink was inhibited.

(Agglomeration Inhibition (not Under Evaporation))

Evaluation of “agglomeration inhibition (not under evaporation) was performed according to a method similar to that for the evaluation of “agglomeration inhibition (under evaporation)” in all aspects except the following change. In the evaluation of “agglomeration inhibition (not under evaporation)”, the beaker was sealed with a parafilm in the storage so as not to allow evaporation. No condensation of the pigment components due to solvent evaporation occurred in the evaluation of “agglomeration inhibition (not under evaporation)”. Therefore, the evaluation of “agglomeration inhibition (not under evaporation)” is evaluation under more moderate conditions than the evaluation of “agglomeration inhibition (under evaporation)”.

(Filling Liquid Flow-Out Ability)

An unused recording head (“KJ4B-QA”, product of KYOCERA Document Corporation, total number of nozzles: 2656) was washed with pure water and then sufficiently dried. The recording head was filled with 25 mL of the filling liquid (any of the filling liquids (F-1) to (F-19)) included in the ink set being the evaluation target. Thereafter, the recording head in a capped state was left to stand at 60° C. for 2 weeks (standing treatment). After the standing treatment, the filling liquid was discharged from the recording head by ejecting the filling liquid from the recording head. Thereafter, 100 mL of the corresponding ink (any of the inks (I-1) to (I-6)) of the ink set being the evaluation target was filled into the recording head. Thereafter, a nozzle check pattern was printed on recording paper using the recording head filled with the ink. Next, the recording paper was read using a scanner to count the number (ejection nozzle count) of ejection nozzles that have ejected the ink. Using the following formula, a rate [%] (ink installation rate) of the number of the ejection nozzles to the total number (2656) of nozzles of the recording head was obtained. The filling liquid flow-out ability was evaluated based on the following criteria.

Ink installation rate=100×number of ejection nozzles/total number of nozzles

(Evaluation Criteria for Filling Liquid Flow-out Ability)

A (acceptable): ink installation rate of at least 90%

B (rejected): ink installation rate of less than 90%

(Filling Liquid Flow-In Ability)

An unused recording head (“KJ4B-QA”, product of KYOCERA Document Corporation, total number of nozzles: 2656) was washed with pure water and then sufficiently dried. The recording head was filled with 25 mL of the filling liquid (any of the filling liquids (F-1) to (F-19)) included in the ink set being the evaluation target. Thereafter, the filling liquid was discharged from the recording head by ejecting the filling liquid from the recording head. The above operation was performed 10 times in total (total filling 250 mL). Thereafter, the filling liquid was re-filled into the recording head. Thereafter, a nozzle check pattern was printed on a glass plate using the recording head filled with the filling liquid. In the manner described above, the nozzle check pattern was formed on the glass plate with the filling liquid. Next, the glass plate was scanned using a scanner to count the number (ejection nozzle count) of ejection nozzles from which the filling liquid has been ejected. A rate [%] (flow-in rate) of the number of the ejection nozzles to the total number (2656) of the nozzles of the recording head was obtained using the following formula. The filling liquid flow-in ability was evaluated based on the following criteria.

Flow-in rate=100×number of ejection nozzle/total number of nozzles

(Evaluation Criteria for Filling Liquid Flow-in Ability)

A (acceptable): flow-in rate of at least 90%

B (rejected): flow-in rate of less than 90%

(RED)

The radius R₀ of the Hansen sphere of each of the inks (I-1) to (I-6) was measured according to the method described in the first embodiment. Also, HSPs of each filling liquid were calculated according to the method described in the first embodiment. In calculation of the HSPs of each filling liquid, the HSPs (also referred to below as HSPs not under evaporation) of each composition shown in Tables 3 to 5 were calculated and the HSPs (also referred to below as HSPs under evaporation) of each composition shown in Tables 3 to 5 from which water has been removed were also calculated. “HSPs (under evaporation)” assume a situation in which water has been lost from the filling liquid by evaporation due to dryness in the recording head.

The radius R₀ of the Hansen sphere of each ink (I-1) to (I-7) was 16.0 [MPa^{1/2}].

A relative energy difference (RED) between the filling liquid and the ink was calculated for each of the ink sets. In detail, with respect to each of the ink sets, a distance Rₐ between a corresponding filling liquid and a corresponding ink in the Hansen space was calculated using the formula (R-1) described in the first embodiment. In calculation of the distance Rₐ, the “HSPs (not under evaporation)” or the “HSPs (under evaporation)” were used as the HSPs of the filling liquid. Next, a RED was calculated from the distance Rₐ and the radius R₀ of the Hansen sphere of the ink using the formula (r) described in the first embodiment. In Tables 6 to 8 below, the RED calculated using the “HSPs (not under evaporation)” as the HSPs of the filling liquid was taken to be “RED (not under evaporation)” and the RED calculated using the “HSPs (under evaporation)” as the HSPs of the filling liquid was taken to be “RED (under evaporation)”.

TABLE 6

| | | Example | | | | | | | | |
|---|---|---|---|---|---|---|---|---|---|---|
| | | 1 | 2 | 3 | 4 | 5 | 6 | 7 | 8 | 9 |
| Ink | | I-4 | I-4 | I-4 | I-4 | I-4 | I-4 | I-4 | I-4 | I-4 |
| Filling liquid | | F-1 | F-2 | F-3 | F-4 | F-5 | F-6 | F-7 | F-8 | F-9 |
| RED (under evaporation) | | 0.97 | 0.86 | 0.98 | 0.96 | 0.96 | 0.97 | 0.97 | 0.96 | 0.98 |
| RED (not under evaporation) | | 0.73 | 0.60 | 0.77 | 0.70 | 0.73 | 0.73 | 0.73 | 0.73 | 0.77 |
| Evaluation | Agglomeration inhibition | A | A | A | A | A | A | A | A | A |
| result | (under evaporation) | | | | | | | | | |
| | Agglomeration inhibition | A | A | A | A | A | A | A | A | A |
| | (not under evaporation) | | | | | | | | | |
| | Filling liquid flow-out ability | A | A | A | A | A | A | A | A | A |
| | Filling liquid flow-in ability | A | A | A | A | A | A | A | A | A |

TABLE 7

| | | Comparative Example | | | | | | Example | | | |
|---|---|---|---|---|---|---|---|---|---|---|---|
| | | 1 | 2 | 3 | 4 | 5 | 6 | 10 | 11 | 12 | 13 |
| Ink | | I-4 | I-4 | I-4 | I-4 | I-4 | I-4 | I-1 | I-2 | I-3 | I-5 |
| Filling liquid | | F-10 | F-11 | F-12 | F-13 | F-14 | F-15 | F-1 | F-1 | F-1 | F-1 |
| RED (under evaporation) | | 0.95 | 0.96 | 0.77 | 0.95 | 0.95 | 0.98 | 0.97 | 0.97 | 0.97 | 0.97 |
| RED (not under evaporation) | | 0.74 | 0.70 | 0.62 | 0.62 | 0.62 | 0.74 | 0.73 | 0.73 | 0.73 | 0.73 |
| Evaluation | Agglomeration inhibition | B | B | B | B | A | A | A | A | A | A |
| result | (under evaporation) | | | | | | | | | | |
| | Agglomeration inhibition | A | A | A | A | A | A | A | A | A | A |
| | (not under evaporation) | | | | | | | | | | |
| | Filling liquid flow-out ability | A | A | B | A | A | B | A | A | A | A |
| | Filling liquid flow-in ability | B | A | A | A | B | B | A | A | A | A |

TABLE 8

| | | Comparative Example | | | | |
|---|---|---|---|---|---|---|
| | | 7 | 8 | 9 | 10 | 11 |
| Ink | | I-6 | I-4 | I-4 | I-4 | I-4 |
| Filling liquid | | F-1 | F-16 | F-17 | F-18 | F-19 |
| RED (under evaporation) | | 0.98 | 0.97 | 0.96 | 1.10 | 0.96 |
| RED (not under evaporation) | | 0.76 | 0.76 | 0.70 | 0.90 | 0.70 |
| Evaluation | Agglomeration inhibition | B | B | B | B | B |
| result | (under evaporation) | | | | | |
| | Agglomeration inhibition | A | A | A | B | B |
| | (not under evaporation) | | | | | |
| | Filling liquid flow-out ability | A | A | A | A | A |
| | Filling liquid flow-in ability | A | B | A | A | A |

As shown in Tables 1 to 8, each of the ink sets of Examples 1 to 13 included an ink and a filling liquid. The ink contained a pigment, a pigment covering resin, a glycol ether compound, a first polyhydric alcohol compound, and water. The filling liquid contained polyethylene glycol, a second polyhydric alcohol compound, a nonionic surfactant, and water. The polyethylene glycol had a mass average molecular weight of at least 190 and no greater than 420. The percentage content of the polyethylene glycol in the filling liquid was at least 0.7% by mass and no greater than 12.0% by mass. The percentage content of the second polyhydric alcohol compound in the filling liquid was at least 15.0% by mass and no greater than 45.0% by mass. In each of the ink sets of Examples 1 to 13, the filling liquid easily flowed into the ink flow channel of the recording head and easily flowed out of the recording head and agglomeration of the pigment components of the ink in the recording head was effectively inhibited.

By contrast, the filling liquid (F-10) included in the ink set of Comparative Example 1 had a percentage content of the polyethylene glycol of greater than 12.0% by mass. The viscosity of the filling liquid (F-10) was high due to an excessive amount of the polyethylene glycol. As a result, it was difficult for the filling liquid of the ink set of Comparative Example 1 to flow into the ink flow channel of the recording head. In addition, the ink set of Comparative Example 1 also did not inhibit agglomeration of the pigment components of the ink in the recording head.

The filling liquid (F-11) included in the ink set of Comparative Example 2 had a percentage content of the polyethylene glycol of less than 0.7% by mass. It is thought that the filling liquid (F-11) would not ensure sufficient solubility of the surfactant upon exposure to a dry state because of insufficiency in polyethylene glycol. As a result, the ink set of Comparative Example 2 did not inhibit agglomeration of the pigment components of the ink in the recording head.

The filling liquids (F-12) and (F-13) respectively included in the ink set of Comparative Examples 3 and 4 each had a percentage content of the second polyhydric alcohol of less than 15.0% by mass or greater than 45.0% by mass. It is thought that the influence of the glycol ether compound on reducing dispersion stability of the pigment components would not be reduced in the filling liquids (F-12) and (F-13) because of inadequate amount of the second polyhydric alcohol compound. As a result, the ink sets of Comparative Examples 3 and 4 each did not inhibit agglomeration of the pigment components of the ink in the recording head. Furthermore, the filling liquid of the ink set of Comparative Example 3 was difficult to flow out of the recording head.

The filling liquid (F-14) included in the ink set of Comparative Example 5 contained no nonionic surfactant. As a result, the filling liquid of the ink set of Comparative Example 5 was difficult to flow into the recording head.

In the filling liquid (F-15) of the ink set of Comparative Example 6, the polyethylene glycol had a mass average molecular weight of greater than 420. Due to containing polyethylene glycol with a large molecular weight, the filling liquid (F-15) had a high viscosity. As a result, it was difficult for the filling liquid of the ink set of Comparative Example 6 to flow into the ink flow channel of the recording head. Furthermore, it was difficult for the filling liquid of the ink set of Comparative Example 6 to flow out of the recording head.

The ink (I-6) included in the ink set of Comparative Example 7 did not contain the first polyhydric alcohol compound. It is thought that the influence of the glycol ether compound on reducing dispersion stability of the pigment components would not be reduced in the ink (I-6) because of no containment of the first polyhydric alcohol compound. As a result, the ink set of Comparative Example 7 did not inhibit agglomeration of the pigment components of the ink in the recording head.

The filling liquids (F-16) and (F-17) respectively included in the ink sets of Comparative Examples 8 and 9 did not contain polyethylene glycol. It is thought that the filling liquids (F-16) and (F-17) would not ensure sufficient solubility of the surfactant upon exposure to a dry state because of no contentment of polyethylene glycol. As a result, the ink sets of Comparative Examples 8 and 9 did not inhibit agglomeration of the pigment components of the corresponding inks in the recording head. Furthermore, it was difficult for the filling liquid of the ink set of Comparative Example 8 to flow into the ink flow channel of the recording head.

The filling liquid (F-18) included in the ink set of Comparative Example 10 did not contain the second polyhydric alcohol compound. It is thought that the influence of the glycol ether compound on reducing dispersion stability of the pigment components would not be reduced in the filling liquid (F-16) because of no containment of the second polyhydric alcohol compound. As a result, the ink set of Comparative Example 10 did not inhibit agglomeration of the pigment components of the ink in the recording head.

The filling liquid (F-19) included in the ink set of Comparative Example 11 contained no nonionic surfactant. It is thought that the filling liquid (F-19) would not increase dispersion stability of the pigment components because of no containment of a nonionic surfactant. As a result, the ink set of Comparative Example 11 did not inhibit agglomeration of the pigment components of the ink in the recording head.

What is claimed is:

1. An ink set comprising an inkjet ink and a recording head filling liquid, wherein
the inkjet ink contains a pigment, a pigment covering resin, a glycol ether compound, a first polyhydric alcohol compound, and water,
the recording head filling liquid contains polyethylene glycol, a second polyhydric alcohol compound, a nonionic surfactant, and water,
the polyethylene glycol has a mass average molecular weight of at least 190 and no greater than 420,
a percentage content of the polyethylene glycol in the recording head filling liquid is at least 0.7% by mass and no greater than 12.0% by mass, and
a percentage content of the second polyhydric alcohol compound in the recording head filling liquid is at least 15.0% by mass and no greater than 45.0% by mass.

2. The ink set according to claim 1, wherein
the nonionic surfactant includes an acetylene glycol-based surfactant.

3. The ink set according to claim 1, wherein
a percentage content of the nonionic surfactant in the recording head filling liquid is at least 0.01% by mass and no greater than 0.10% by mass.

4. The ink set according to claim 1, wherein
the recording head filling liquid has a viscosity of at least 2.5 mPa·s and no greater than 10.0 mPa·s.

5. The ink set according to claim 1, wherein
the glycol ether compound includes triethylene glycol monobutyl ether.

6. The ink set according to claim 1, wherein
the pigment covering resin includes a styrene-acrylic resin.

7. The ink set according to claim 1, wherein
the recording head filling liquid is used in a manner to be filled into a recording head in which the inkjet ink remains.

8. A recording head inspection method that uses the ink set according to claim 1, the method comprising:
performing inspection to inspect ejection performance of a recording head; and
filling the recording head filling liquid into the recording head after the performing inspection, wherein
in the performing inspection, the ejection performance of the recording head is inspected by ejecting the inkjet ink from the recording head.
